(19) United States
(12) Patent Application Publication
(10) Pub. No.: US 2002/0164189 A1
(43) Pub. Date: Nov. 7, 2002

(54) Computer Keypad

(76) Inventor: Jeffery H. Glassover, Naples, FL (US)

Correspondence Address: Allen D. Brufsky, Esq., Allen D. Brufsky, P.A., 8930 Bay Colony Drive, Unit # 604, Naples, FL, 34108, US

(21) Appl. No.: 09/850,670

(22) Filed: May 7, 2001

(51) Int. Cl. B41J 5/08

(52) U.S. Cl. 400/477

(57) ABSTRACT

A standard keyboard structure of a computer is modified wherein one or more of the numeric, function or letter keys are replaced with a multimedia key to digitally display, when struck, a multimedia symbol. One example of such a key would be “http://” as the upper case portion and “.org” as the lower case. Other combinations would include “www.” as the upper case and “.com” as the lower case portion of the key, or similar combinations useful for accessing, for example, the internet or worldwide web.

### FIELD OF THE INVENTION

This invention relates to a computer keypad and more particularly, to a keypad employing various symbols to be typed on the computer to enhance connection of the computer to the internet.

### DESCRIPTION OF THE PRIOR ART

It has been proposed to provide a computer keyboard with a number of expanded function keys, so the operator may directly control the existing functions of a multimedia peripheral device or applications program in the operating system of a computer. For example, in U.S. Pat. No. 6,011,495 to Chen, a modified standard keyboard is disclosed with the numeric keypad made to connect directly to multimedia functions, such as, by depressing a www. key, the internet or world wide net may be directly accessed by depressing the key. Other special keys are disclosed in U.S. Pat. Nos. 5,181,029; 5,897,257; 5,986,586; and 6,100,875 for directly connecting, upon depressing the key, to a specific multimedia function. However, the prior art is devoid of a key on a computer keyboard or template covering the keyboard or keypad, for electronically or mechanically displaying the appropriate symbol upon being activated or depressed in a computer program but once for making a connection to a multimedia application, such as the worldwide web or internet.

### SUMMARY OF THE INVENTION

Accordingly, this invention proposes that a standard keyboard structure of a computer be modified wherein one or more of the numeric, function or letter keys be replaced with a multimedia key to digitally display, when struck, a multimedia symbol. One example of such a key would be “http://” as the upper case portion and “.org” as the lower case. Other combinations would include “www.” as the upper case and “.com” as the lower case portion of the key, or similar combinations useful for accessing, for example, the internet or worldwide web.

### BRIEF DESCRIPTION OF THE DRAWING

Further objects and advantages of the invention will become more apparent from the following description and claims and from the accompanying drawings, wherein:

FIG. 1 is a perspective view of a computer keyboard provided with one or more of the keys of the present invention; and

FIGS. 2 and 3 are plan views of one of the keys illustrated in the keyboard of FIG. 1.

### DETAILED DESCRIPTION OF THE PREFERRED EMBODIMENT

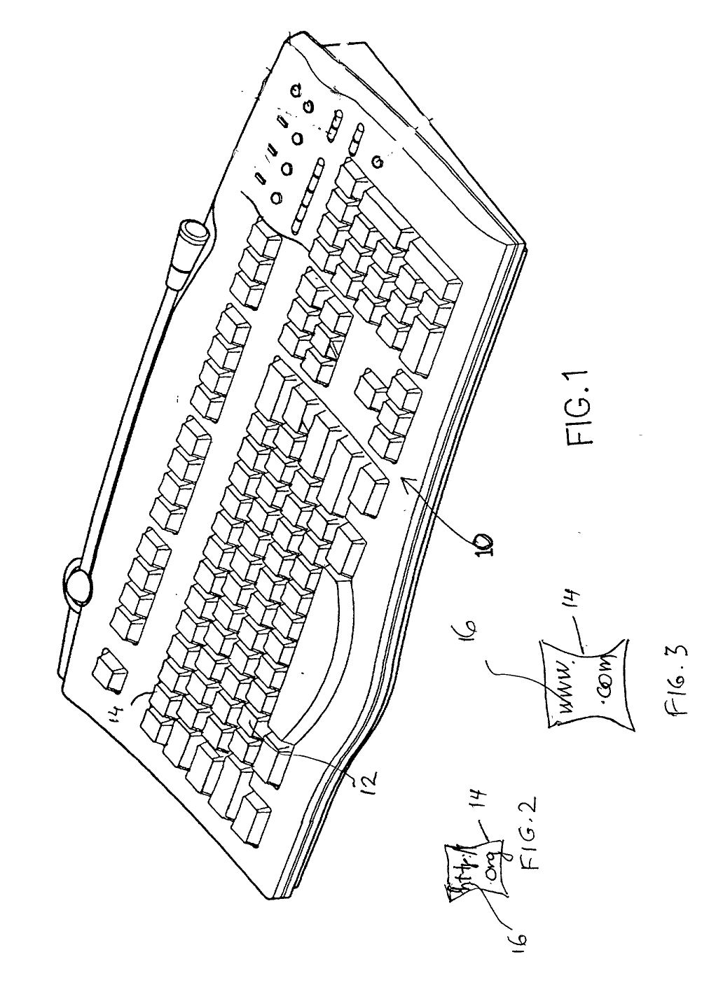

Referring now to the drawings in detail, wherein like numerals indicate like elements throughout the several views, FIG. 1 illustrates a standard computer keyboard 10 provided with one or more keys 12 which are produced in accordance with the invention.

According to one embodiment of the invention, one of the keys 14 on the keyboard 10 can replace a standard numeric, letter or function key and have imprinted on its face indicia 16 corresponding to one or more identifiers for connecting to the worldwide web or internet. In particular, FIG. 2 illustrates that the key 14 can have indicia 16 wherein the upper case portion of the key will imprint or digitally display the symbol “http://”, while the lower case indicia can be “.org”. FIG. 3 illustrates that the key 14 can have indicia 16 which will imprint or digitally display the symbol “www.” when the upper case portion is activated, while the lower case can print or digitally display the term “.com” commonly associated with certain websites. The manner of accomplishing such digital display is well known in the art and can be implemented for example, by a keyboard driver contained within a programmable microcontroller connected to software provided with a host computer connected to keyboard 10.

While particular embodiments of the present invention have been illustrated and described, it would be obvious to those skilled in the art that various changes and modifications can be made without departing from the spirit and scope of the invention for example; the indicia on the keys to actuate the digital display may be modified to identify other internet applications. It is therefore intended to cover in the appended claims all such changes and modifications that are within the scope of the present invention.

1. A computer keyboard comprising:
a plurality of keys, said keys being interconnected with a keyboard driver disposed within said keyboard and connected to said computer, and
at least one of said keys bearing indicia relating to identifying at least a portion of a worldwide web address on its face and when activated displaying said indicia on a computer screen.

2. The computer keyboard of claim 1 wherein said one key has an upper case indicia and lower case indicia alternatively displayed through said driver.

3. The computer keyboard of claim 2 wherein said upper case indicia on said key is http://.

4. The computer keyboard of claim 3 wherein said lower case indicia is .org.

5. The computer keyboard of claim 2 wherein said upper case indicia is www.

6. The computer keyboard of claim 5 wherein said lower case indicia is .com.
